(19) United States
(12) Patent Application Publication
(10) Pub. No.: US 2009/0216382 A1
(43) Pub. Date: Aug. 27, 2009

(54) Direct Load Control System and Method with Comfort Temperature Setting

(76) Inventor: Howard Ng, Towaco, NJ (US)

Correspondence Address: PHILIP H. BURRUS, IV, 460 Grant Street, Atlanta, GA, 30312, US

(21) Appl. No.: 12/037,709

(22) Filed: Feb. 26, 2008

(51) Int. Cl. G05D 23/00

(52) U.S. Cl. 700/278

(57) ABSTRACT

A method (700) and system (100) for facilitating direct load control in an HVAC system while maintaining customer comfort is provided. A local controller (101) coupled to a HVAC system, receives direct load control signals from a remote source (111), such as an energy provider or utility. An analysis module (106) concurrently monitors the ambient temperature at the customer location. Where the ambient temperature reaches or exceeds a maximum temperature set point, the analysis module (106) modifies the load control signals to cause a local load (102), such as an air conditioner or heat pump, to maintain a customer comfort level.

### BACKGROUND

1. Technical Field

This invention relates generally direct load control systems, and more particularly to a method and system of facilitating direct load control while guarding against excessive temperature rise at a customer location.

2. Background Art

Energy consumption is on the rise. Businesses, residences, and public facilities all rely on energy for communication, entertainment, and transportation. One area in which energy is particularly important is the field of heating and cooling. Heating, ventilation, and air conditioning (HVAC) systems consume energy to keep people cool in the summer and warm in the winter.

Power generation companies, distribution companies, and utilities work to deliver energy to customers across a power distribution network, or “grid.” While the grid is a reliable conduit for transporting energy from generation site to consumption site, the capacity of the grid, as well as the energy generation devices that supply power to the grid, is finite. Further, when demand spikes, it takes time to bring additional generation devices on line. Consequently, energy companies are often concerned with energy demand, or “load.” For example, when demand is unusually high, such as the demand from air conditioning loads on a particularly hot day, energy companies sometimes have to use auxiliary or back-up power generation to supply the necessary demand. The fuel costs for this back-up power generation are often substantially higher than for conventional generation. Additionally, there are times when demand can overwhelm the grid.

To help with demand concerns, some energy companies have initiated “direct load control” or demand response programs. Direct load control is a method where energy suppliers may interrupt the loads of their consumers during critical demand times. In exchange for permitting this interruption, the consumer generally gets more favorable energy rates because that customer is not consuming energy generated by the auxiliary or back-up devices. To illustrate by example, a homeowner on a direct load control program may find his air conditioner periodically interrupted on hot summer days. In exchange, his utility bill is generally lower than that of customers not on the direct load control plan. Other incentives include home owner compensation in exchange for participating in the program. This load cycling by the energy provider reduces overall energy consumption when electricity demand is highest, thereby improving grid reliability and reducing energy costs for the provider.

One problem associated with direct load control programs is that the customer temporarily loses control of his HVAC system. When the air conditioning is turned off during the hottest part of the day, temperature at the customer location rises. A customer who is unsure just how hot it may get under a direct load control plan may not be inclined to sign up for such a plan.

There is thus a need for an improved direct load control system and method.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a HVAC system configured for direct load control with comfort temperature compensation in accordance with the invention.

FIG. 2 illustrates one embodiment of a HVAC system configured for direct load control with comfort temperature compensation in accordance with the invention.

FIG. 3 illustrates one embodiment of a HVAC system configured for direct load control with comfort temperature compensation in accordance with the invention.

FIG. 4 illustrates one embodiment of a HVAC system configured for direct load control with comfort temperature compensation in accordance with the invention.

FIG. 5 illustrates a prior art direct load control operational graph.

FIG. 6 illustrates an operational graph for a HVAC system configured for direct load control with comfort temperature compensation in accordance with embodiments of the invention.

FIG. 7 illustrates one method for direct load control with comfort temperature compensation in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to local temperature compensation for direct load control systems. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of temperature compensation in direct load control systems as described herein. The non-processor circuits may include, but are not limited to, a radio or other signal receiver, processing circuits, signal drivers, clock circuits, power source circuits, and user input devices. As such, these functions may be interpreted as steps of a method to perform temperature compensation in direct load control systems. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of“a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

As noted above, direct load control is a method used by energy providers where local loads are “cycled”—i.e. they are periodically turned ON and OFF remotely -to reduce energy consumption during times when electricity demand is highest. Energy providers use direct load control as one tool in “demand response” programs where the energy provider takes control of the customer's load to shed capacity at peak intervals.

In a simple direct load control scenario, the energy provider cycles the load—which may be an air conditioner on a hot day—by capping a run time per unit time of the load. By way of example, when an energy provider employs a 50% direct load control setting, the load is only allowed to run 50% of a predetermined time window. Thus, in a given hour of the day, an air conditioner or furnace may be allowed to run only for a maximum of thirty minutes.

If the load is an air conditioner in the home, the temperature of the home will increase when the air conditioner has been turned off due to the direct load control plan. If, for example, a home owner had the thermostat set on 78 degrees, thereby causing the air conditioner to run for 45 minutes of every hour, a direct load control setting of 50% may cause the temperature of the home to increase to 81 degrees, as air conditioning run time is limited to 30 minutes in any given hour.

Where the temperature tends to be hot in the summer, in the deep south or southwest for example, and where the direct load control setting is high, the temperature in a customer's home may rise to a truly uncomfortable level. In the scenario above, if the direct load control setting is 70%, the temperature may rise to 85 degrees or more in warm climates. Such high temperatures may discourage customers from signing up for the direct load control program. The temperature rise problem can be exacerbated by local conditions such as poor home insulation or construction, undersized HVAC equipment, or thermal rise due to solar effects.

Embodiments of the present invention provide a system and method for providing direct load control, yet ensuring a certain comfort level to the end user. In one embodiment, for example, the system guards against excessive temperature rise, and thus assists in keeping the end customer comfortable by setting a maximum temperature set point that modifies the direct load control setting based upon a local temperature. For instance, a maximum temperature set point may be established such that when the ambient temperature in a customer's home reaches maximum temperature set point, the direct load control percentage is decreased. This decrease in the direct load control percentage causes the air conditioner to run more than it would on a conventional direct load control program such that a more comfortable temperature is maintained at the customer location.

The modification of the direct load control setting may be performed in one of a variety of ways. First, the direct load control setting may be scaled by a predetermined factor. For example, where the direct load control setting is 50% and the maximum temperature set point is reached, the direct load control setting may be scaled by a predetermined factor, such as 0.8. Thus, the new direct load control setting becomes 40%. This scalar, or modification variable, may be either stored in a local memory or sent to local control circuitry over a communication network.

Next, local data may be incorporated when performing the direct load control setting modification. For instance, the rate of rise in temperature at the customer's dwelling may be used in the modification of the direct load control setting. By way of example, a direct load control setting of 50% may be first scaled by a factor, and then scaled again by a function of the rise in local temperature.

Third, a function of time may be used, such as time remaining in the direct load control window. If, for example, the window is an hour and the direct load control setting is 50%, such that the air conditioner runs no more than 30 minutes in a given hour, the direct control setting may be modified by a scalar, a function of the rise in local temperature, and a function of the time remaining until the next direct load control window opens. Thus, where temperature rises excessively and there is a long time remaining until the next direct load control window or hour opens, the direct load control setting may be altered more than it would be if time were not considered.

Next, a minimum cycle percentage may be specified and may override the direct load control setting when the maximum temperature set point is reached. In such a scenario, where the direct load control setting is 50% and the minimum cycle percentage is 40%, load cycling becomes 40% for any direct load control window in which the maximum temperature set point is reached or exceeded.

In another embodiment, the maximum temperature set point becomes an override itself and maintains the room temperature at the maximum temperature set point. Once the maximum temperature set point is reached, the direct load control setting is temporarily overridden, i.e., turned OFF, to allow the HVAC system to run freely. Once the room temperature falls below the maximum temperature set point, the load control setting is re-engaged to reduce the HVAC compressor run time and allow the temperature to rise again. Time delay can be used on the load control override and re-engagement transitions to prevent rapid and frequent cycling of the HVAC system. The net effect of this embodiment is that the room temperature is maintained to the maximum temperature set point.

In another embodiment where two-way communication is used, once the maximum temperature set point is reached, a status signal can be sent to the utility or energy provider. Based upon the number of homes that have reached the maximum set point at a given time, combined with the amount of load reduction required, the utility or energy provider may determine to modify the load control setting accordingly.

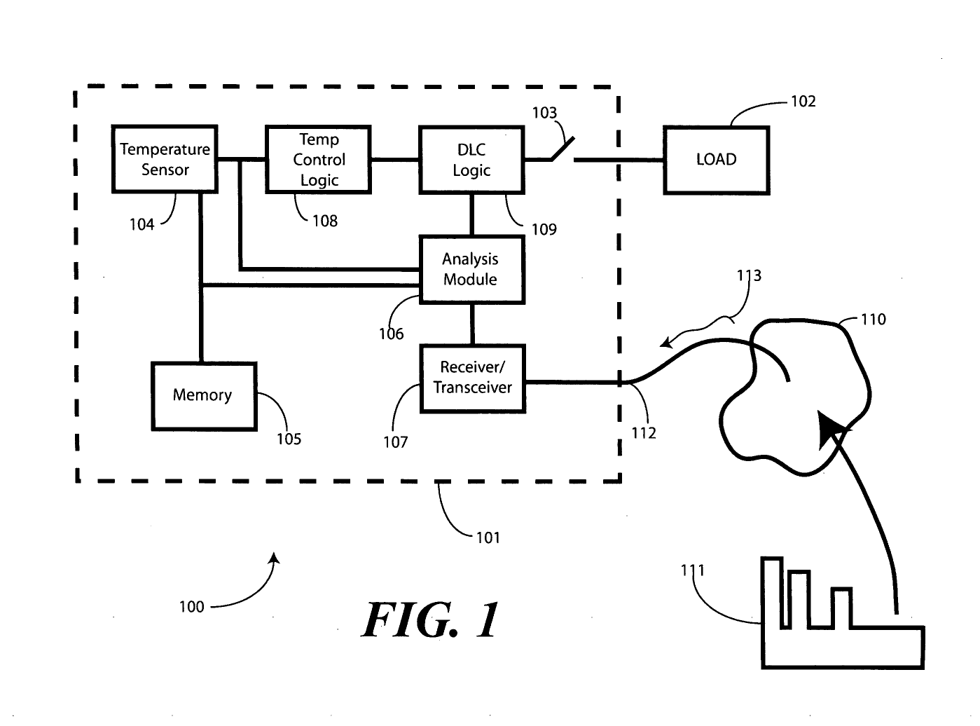

Turning now to FIG. 1, illustrated therein is one embodiment of an HVAC control system 100 configured to implement direct load control with comfort temperature compensation in accordance with the invention. The system 100 includes a local controller 101 having a communication connection 112 configured to receive load control signals 113 from a remote source 111, such as an energy provider or a utility. The local controller 101 is a device that includes processing circuitry or logic, such as a microprocessor or custom logic, and is configured to turn a load 102 ON and OFF.

One example of a local controller 101 may be a programmable or intelligent thermostat that is disposed inside the dwelling, such as those manufactured by White Rogers or Honeywell. Alternatively, the local controller 101 may an auxiliary device capable of turning the load 102 ON or OFF, in addition to the thermostat. One such device is a Digital Control Unit (DCU) box manufactured by Comverge, Inc. A DCU box is designed to be coupled outside the dwelling, near the air compressor. The DCU box may be used for communication through various channels as well, including through wide area and local area networks. A third example of a local controller 101 is a computational device such as a computer or dedicated processing unit that is coupled to the HVAC system.

The local controller 101 turns the load 102 ON or OFF, i.e. actuates the load 102, by way of a switch 103. The switch 103 may be located within the local controller 101, such as is the case with a thermostat or DCU box. Alternatively, the switch 103 may be located outside the local controller 101. Such an external switch is still under the control of the local controller 101 in accordance with embodiments of the invention.

A temperature sensor 104 is coupled to the local controller 101. The temperature sensor 104 senses an ambient temperature at the customer's location. Where the local controller 101 is a thermostat, for example, the temperature sensor 104 may simply be the internal temperature sensor of the thermostat. Where the local controller 101 is a DCU box, the temperature sensor 104 may be the temperature sensor of a thermostat disposed within the dwelling, or it may be a separate temperature sensor capable of communication with the DCU box by wired or wireless communication channels.

As the local controller 101 is configured to implement direct load control, it includes a communication connection 112 that is configured to receive load control signals 113 from a remote source 111, such as an energy provider or utility. When direct load control is in effect, the energy provider or utility may send load control signals 113 to the local controller 101 across a network 110. In one embodiment, the load control signals 113 include local load interrupt information, such as direct load control settings. In one embodiment, the direct load control settings comprise a maximum run time per unit time for the load 102. A communication receiver circuit 107, such as a modem, network card, or other CODEC, receives the load control signals 113 and delivers them to the direct control circuit 109.

When an energy provider or utility detects that load conditions are becoming critical—perhaps when demand is high on a summer day—the energy provider may transmit a load control signal 113 with a direct load control setting of 50%. Such a load control signal 113 removes load 102 from “free operation” and limit its run time as discussed above. Under direct load control, the load control signal 113 often includes a maximum run time per time unit. In this example the maximum run time is 30 minutes and the time unit is an hour.

Upon receipt of the load control signal 113 by the local controller 101, direct load control logic 109 begins to actuate the load 102 in accordance with the direct load control settings. Specifically, the load control logic 109 overrides control signals generated by the traditional temperature control logic 108. Where the local controller 101 is a thermostat for instance, the temperature control logic 108 may “call” for air conditioning when the thermostat is set for 78 degrees and the temperature sensor 104 detects that the ambient temperature of 80 degrees. However, when direct load control is in effect, the load control logic 109 may override this to ensure that the air conditioner runs in accordance with the load interrupt information received from the remote source 111. Said differently, where the load control signal 113 includes a maximum run time per time unit, when the maximum run time per time unit is exceeded the load control logic 109 actuates the switch 103 so as to deactuate the local load 102.

To prevent excessive temperature rise caused by the load control logic activity, an analysis module 106 is configured to modify the load control signals 113. In one embodiment, the analysis module 106 modifies the load control signals 113 based upon the ambient temperature as sensed by the temperature sensor 104. Specifically, the analysis module 106, which may be a microprocessor or logic chip within the local controller 101, retrieves or determines a maximum temperature set point, and may modify the load control signals 113 whenever the temperature sensor 104 senses a temperature above the maximum temperature set point. Note that in determining whether the ambient temperature is above the maximum temperature set point, the temperature sensor 104 may periodically sample the ambient temperature, such as once per minute.

When the temperature is below the maximum temperature set point, the analysis module 106 permits the direct load control to function normally. Where the temperature reaches or exceeds the maximum temperature set point, the analysis module begins to modify the load control signals to keep the customer comfortable. In one embodiment, the analysis module 106 is configured to prevent the switch 103 from deactuating the local load 102 whenever the ambient temperature is above the maximum temperature set point. The maximum temperature set point, in one embodiment, is a range of between one and fifteen degrees above a mean, with an exemplary default being about six degrees above the mean. In one embodiment, the default may be adjusted by the customer as desired.

As briefly set forth above, the analysis module 106 may alter the load interrupt information in a variety of ways. Note also that hysteresis may be added to the system to prevent the modified load control signal from repetitively cycling the load. In one embodiment, the analysis module 106 samples the ambient temperature several times while load control signal modification is in process to provide this hysteresis. For example, where direct load control is occurring, and the modification of the load control signals is occurring, the analysis module 106 may sample five temperature measurements prior to ceasing load control signal modification to ensure that excessive cycling does not occur.

The analysis module 106 may scale the load interrupt information by a predetermined factor. The factor may be either stored in memory 105 or delivered from the remote source 111. Exemplary factors may be in a range of 1% to 100%, with an exemplary default value being a 50% increase in run time when the ambient temperature is above the maximum temperature set point. An exemplary modification of the direct load control setting would be:

DLC %=Original DLC % *Modification % (EQ. 1)

In an alternate embodiment, the analysis module 106 detects the rise in temperature once direct load control commences. A dramatic rise in local temperature may be indicative of a dwelling that is poorly insulated. Thus, the more rapid the rise in temperature, the more the analysis module 106 would need to throttle back the direct load control to keep the customer comfortable. As such, the analysis module 106 in this embodiment scales the direct load control setting by both a scalar and a function of the rise in local temperature. As such, in this embodiment the analysis module 106 is configured to prevent the switch 103 from deactuating the load 102 by scaling the direct load control setting by a function of the inverse of the change in ambient temperature across a predetermined time interval. An exemplary modification of the direct load control setting would be:

DLC %=Original DLC %*function (1/Rate of Temp Rise) (EQ. 2)

In another embodiment, the analysis module 106 may take the time remaining until a new direct load control window opens when modifying the load control signals. As noted above, in many applications, direct load control is implemented per unit time. Thus, a direct load control setting of 50% would be per unit of time. The unit of time is frequently an hour. A direct load control setting of 50% would mean that the time that a load could operate is limited to thirty minutes per hour where the first 30 minutes, the load is shut off and the load is allowed to run at the second 30 minute window. In such a scenario, when the maximum temperature set point is reached, the analysis module 106 may take the time remaining for load control into account when modifying the load control signals.

To illustrate by example, suppose a load control event of 4 hours is issued at t=0. The load is turned off and begins to run at t=30 minutes. The load then runs for thirty minutes. Assume for the purposes of this example that the maximum temperature set point is reached within the first hour of control. As such, the analysis module 106 would calculate a modification setting based on the three hours of control remaining in the four-hour control event. The more remaining time, the greater the modification in the direct load control setting used to minimize the temperature rise. In one exemplary embodiment, the modification setting would take effect at the start of the second hour, i.e., when t=60 minutes. In such an embodiment the analysis module 106 is configured to prevent the switch 103 from deactuating the load 102 by scaling the direct load control setting by both a function of the inverse of the change in ambient temperature across a predetermined time interval and a function of the inverse of the remaining run time per unit from the maximum run time per unit. An exemplary modification of the direct load control setting might be:

DLC %=Original DLC %*function (1/Temp Rise)*function (1/load control time remain) (EQ. 3)

In another embodiment, the analysis module 106 uses a minimum run percentage stored in memory 105 to modify the load control signal. Specifically, the analysis module modifies the load control signal by substituting the minimum run percentage for the direct load control setting of the load control signal. Thus, where the direct load control setting is 50%, the analysis module 106 will permit this level of load control when the ambient temperature is below the maximum temperature set point. Where the ambient temperature, as sensed by the temperature sensor 104, reaches or exceeds the maximum temperature set point, the analysis module substitutes the minimum run time percentage for the direct load control setting. The load control logic 109 then uses the minimum run time to limit operation of the load 102.

In another embodiment, the analysis module 106 uses a maximum temperature set point stored in memory 105 as the override itself such that the room temperature is maintained at the maximum temperature set point. The analysis module 106 simply temporarily disables the direct load control logic 109 when the ambient temperature is above the maximum temperature set point and re-engages the direct load control logic 109 when the ambient temperature is below the maximum temperature set point.

Note that the maximum temperature set point may be obtained in a variety of ways. In one embodiment, an energy provider or utility delivers the maximum temperature set point as a absolute value to the analysis module 106 through the communication connection 112. The analysis module 106 then stores the maximum temperature set point in memory 105.

Alternatively, the analysis module 106 may determine the maximum temperature set point by way of the temperature sensor 104. Specifically, in one embodiment, the analysis module 106 determines the maximum temperature set point by taking the actual ambient temperature at the start of control and adding the temperature delta value sent by the utility to calculate the maximum temperature set point.

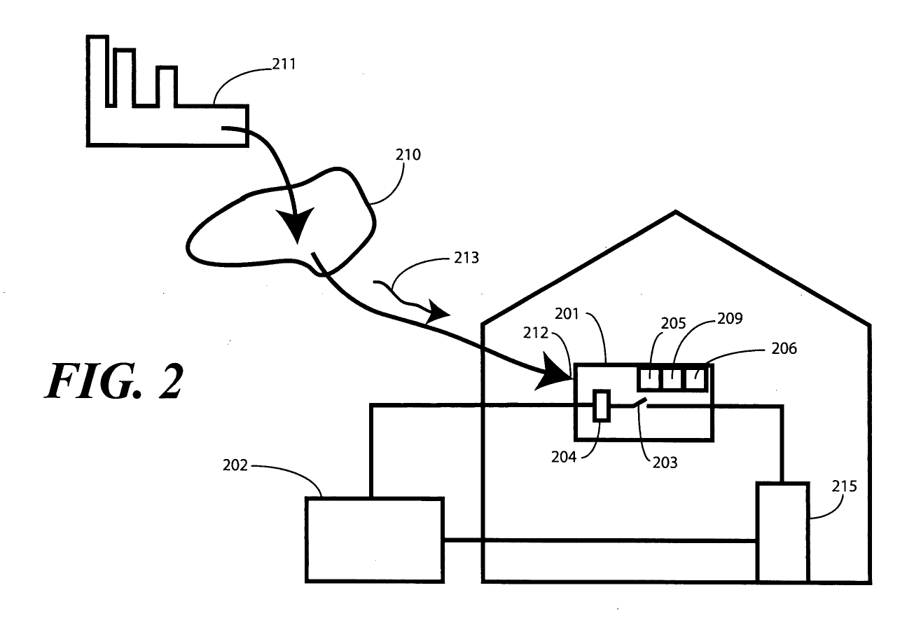

The various components of the system 100, for example the analysis module 106, the temperature sensor 104, the direct load control logic 109, and the switch 103, may be disposed in different devices at the customer's location. Turning now to FIG. 2, illustrated therein is one such configuration where the various control components are disposed within a thermostat.

Specifically, FIG. 2 illustrates a local controller 201 embodied as a thermostat. The thermostat is disposed inside the customer dwelling 214, which in FIG. 2 is a residential home. The load 202 is an air conditioning unit, although it may also be a furnace 215, or a combination of the two.

The main components of the system, including the switch 203, the analysis module 206, the direct load control logic 209, the temperature sensor 204, and the memory 205, are all disposed within the thermostat. Additionally, the thermostat is configured with a communication connection 212. The communication connection may be a dedicated communication port through which a remote source 211, such as an energy provider or a utility, may communicate with the thermostat across a network 210. Alternatively, the communication connection 212 may be a wireless connection configured to receive wireless communication messages from a transmitter. In one embodiment, the communication connection 212 is a Y-line connection, as is described in commonly assigned U.S. Pat. No. 7,163,158 to Rossi et al., entitled “HVAC Communication System.” The use of a Y-line connection allows communication without the need for additional wiring to the thermostat.

The remote source 211 transmits load control signals 213 to the thermostat across the network. As described with reference to FIG. 1, in one embodiment these load control signals 213 include local load interrupt information, such as direct load control settings or maximum run times per unit time. The direct control logic circuitry 209 then actuates the switch 203 so as to deactuate the load 202 in accordance with the local load interrupt information. However, when the analysis module 206 determines that the ambient temperature, as sensed by the temperature sensor 204, exceeds the maximum temperature set point, the analysis module 206 works to modify the load control signals 113 as described above to keep the customer comfortable.

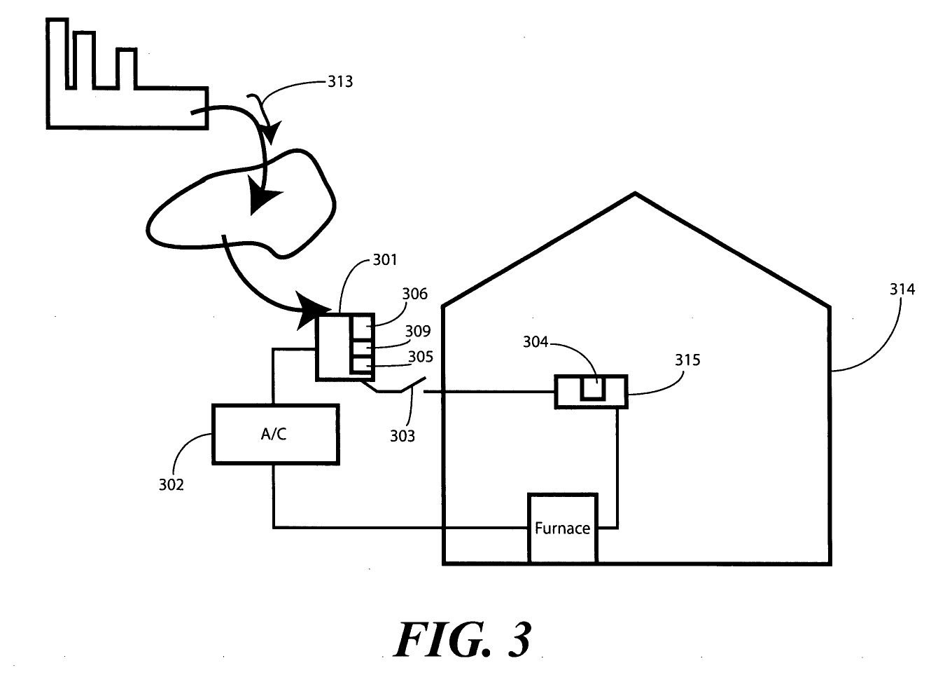

Turning now to FIG. 3, illustrated therein is an alternate embodiment of a system for effecting direct load control with comfort temperature compensation in accordance with the invention. In FIG. 3, the “load actuation components,” such as the memory 305, the analysis module 306, and the direct control logic 309 are disposed outside the dwelling 314. In the exemplary embodiment of FIG. 3, these elements are disposed in a DCU box, which serves as the local controller 301. The DCU box is capable of controlling a switch 303 that is in series with the load 302.

Inside the dwelling 314, a conventional thermostat 315 includes a temperature sensor and a switch. The thermostat 315 communicates temperature sensing information to the local controller 301 such that the analysis module 306 may monitor the ambient temperature inside the dwelling. The temperature information is communicated to the DCU box by one of wireless communications, wired communications, or Y-line communications. As with previous embodiments, when the analysis module 306 detects that the ambient temperature meets or exceeds a maximum temperature set point, the analysis module 306 works to modify the load control signals 313 so as to keep the customer comfortable.

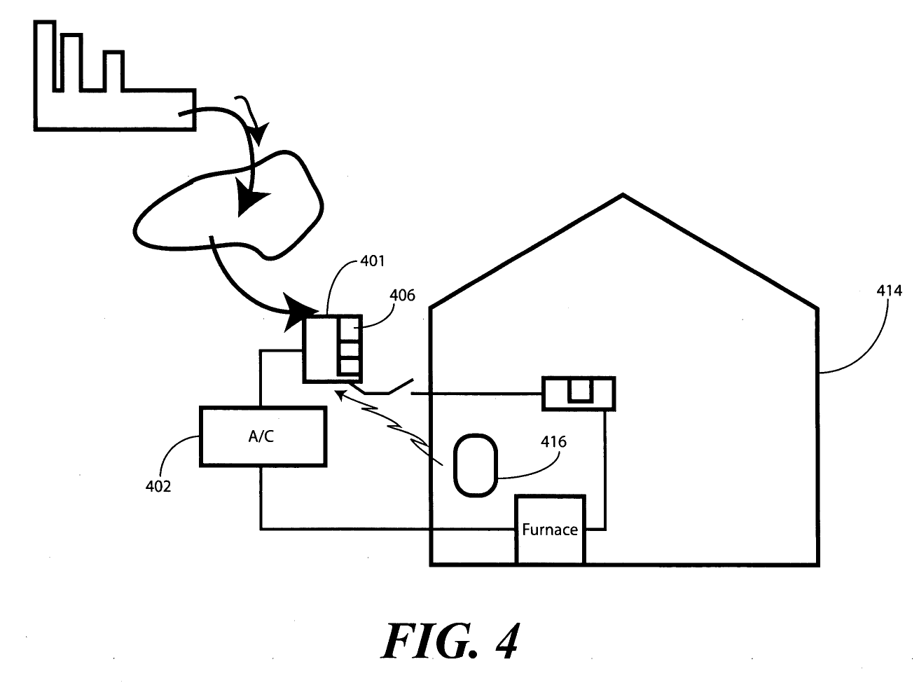

Turning now to FIG. 4, illustrated therein is another embodiment of the invention. FIG. 4 is essentially the same as FIG. 3, except for the temperature sensor. The embodiment of FIG. 4 is suitable for situations where a homeowner does not desire to install an intelligent thermostat.

In FIG. 4, a separate temperature sensor 416 is disposed within the dwelling 414. The temperature sensor 416 monitors the ambient temperature of the dwelling 414. The temperature sensor 416 then wirelessly transmits the temperature information to the local controller 401, which is shown in FIG. 4 as being a DCU box coupled to the load 401. Alternatively, the temperature sensor 416 may transmit temperature information to the local controller 401 by wired communications. The analysis module 406 of the local controller 401 then functions as described above.

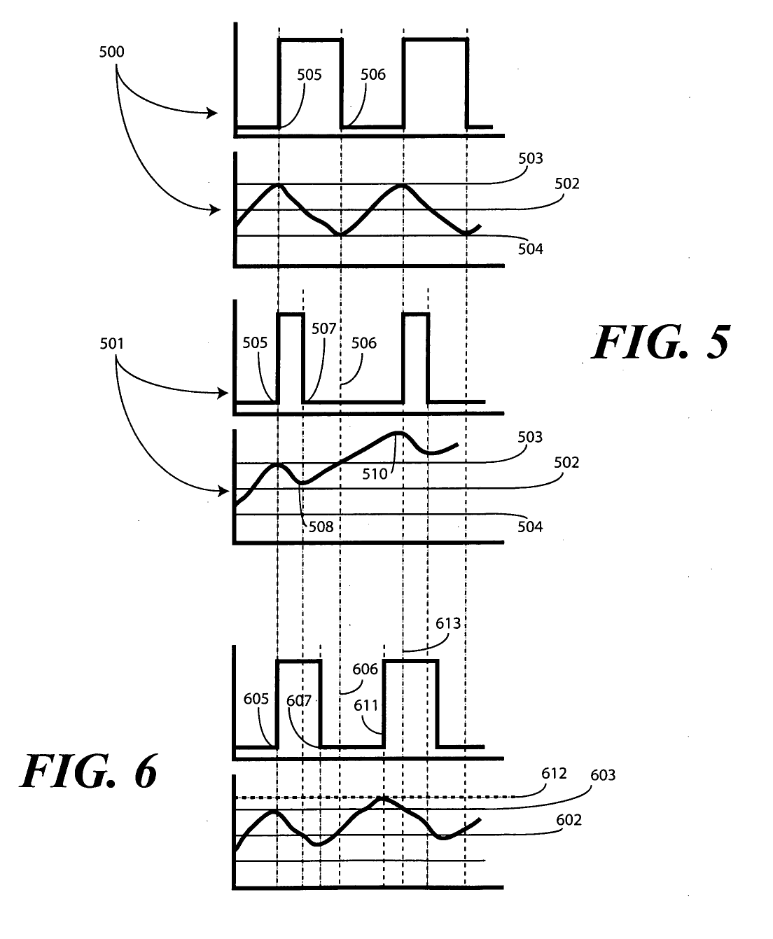

Turning now to FIG. 5, illustrated therein is an operational graph of a prior art direct load control system. For discussion purposes, the load discussed with respect to FIG. 5 will be an air conditioning unit coupled to a residence. It will be obvious to those of ordinary skill in the art having the benefit of this disclosure that other loads may operate in a similar fashion, including heat pumps, water heaters, ovens, and furnaces.

Graph 500 illustrates a load system operating in a normal manner. Temperature oscillates about an ambient temperature set point 502. When the temperature reaches a predetermined amount 503 above the ambient temperature set point 502, the load is turned ON at time 505. When the load has sufficiently cooled the residence, as indicated by the temperature falling below the ambient temperature set point 502 by a predetermined amount 504, the load is turned OFF at time 506.

Graph 501 illustrates the same system under direct load control. When the temperature reaches the predetermined amount 503 above the ambient temperature set point 502, the load is turned ON at time 505. However, rather than running to point 506, as the load would under normal circumstances, direct load control causes the load to turn OFF at time 507. As such, the temperature, as indicated at point 508, does not fall as much as it would under normal conditions. Consequently, the temperature rises to point 510 when the load is actuated again. This increased temperature leads to customer discomfort.

Turning now to FIG. 6, illustrated therein is an operational graph of a system in accordance with embodiments of the invention. As with the graph 501 of FIG. 5, the load turns ON at time 605 when the ambient temperature reaches a predetermined amount 603 above the ambient temperature set point 602. Since the system is under direct load control, the load turns OFF at time 607, rather than point 606 as it would under normal operation, as discussed earlier.

At time 611, the temperature reaches the maximum temperature set point 612. As such, the analysis module of the system modifies the load control signals to cause the load to come ON at time 611 rather than at point 613 as would have been the case under normal direct load control operation. Additionally, depending upon the method of modification used, the load may remain ON longer than it would have under normal direct load control. However, in many cases it will run less than it would under normal operation, thereby still providing load management through shedding to the energy provider or utility.

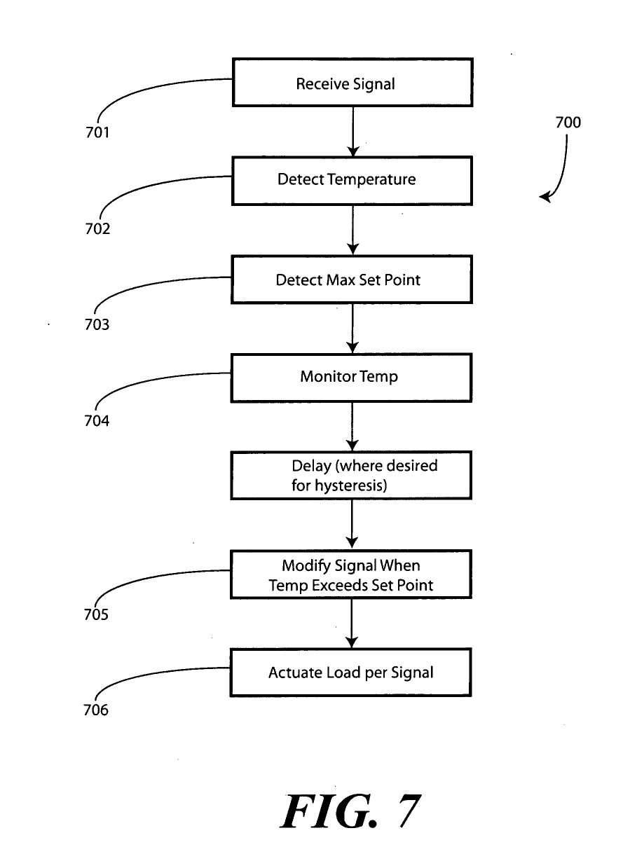

Turning now to FIG. 7, illustrated therein is a method of controlling an HVAC load in accordance with embodiments of the invention. The method, which may be programmed as software that is embedded within the local controller and is operable with the analysis module, provides direct load control while maintaining a minimum customer comfort level.

At step 701, the local controller receives a load control signal from a remote source. As with the systems described above, the load control signal includes load interrupt information, such as a direct load control setting or a minimum run time per unit time.

At step 702, the local controller detects the ambient temperature of the dwelling from a temperature sensor disposed within the dwelling. The local controller also retrieves a maximum temperature set point from a memory. This maximum temperature set point may alternatively be derived by sampling the ambient temperature across a predetermined time when direct load control is not active.

At step 704, the local controller compares the local ambient temperature to the maximum temperature set point. Where the local ambient temperature meets or exceeds the maximum temperature set point, the local controller modifies the local load interrupt information at step 705. The local controller then actuates a load in accordance with the modified local load interrupt information at step 706. For example, in one embodiment the local controller simply actuates the load when the ambient temperature exceeds the maximum temperature set point.

The step 705 of modifying may take different forms, as discussed above. For example, in one embodiment, the step 705 of modifying comprises the step of scaling a maximum local load run time per unit time, as set forth in the local load interrupt information, by a predetermined factor. In another embodiment, the step 705 of modifying comprises the step of scaling the maximum local load run time per unit time by a function of the inverse of a change in ambient temperature across a predetermined time interval.

In another embodiment, the step 705 of modifying the local load interrupt information comprises scaling the maximum local load run time per time unit by a function of an inverse of a change in the ambient temperature across a predetermined time interval scaled by a function of an inverse of a remaining local load run time per time unit from the maximum local load run time per time unit. In another embodiment, the step 705 of modifying the local load interrupt information comprises increasing the maximum local load run time per unit time.

In some situations, it may be helpful for the remote source—i.e. the energy provider or utility—to know just how the local load interrupt information is being modified. For instance, if the remote source expects a load shed of X by initiating direct load control, and only obtains a load shed of Y because a certain percentage of its customers are implementing comfort control by using systems and methods in accordance with embodiments of the present invention, the remote source may wish to have data showing what load shed was actually obtained. As such, in one embodiment, run time information is delivered back to the remote source through the communication connection. Thus, at step 707, the local controller delivers local load interrupt modification information to the remote source.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An HVAC control system, comprising:
a local controller having a communication connection configured to receive load control signals from a remote source, wherein the load control signals comprise local load interrupt information;
a switch coupled to the local controller, the switch being capable of actuating a local load;
a temperature sensor for sensing an ambient temperature coupled to the local controller;
a memory coupled to the local controller configured to store a maximum temperature set point; and
an analysis module, operable with the local controller, configured to modify the load control signals based upon the ambient temperature relative to the maximum temperature set point.

2. The system of claim 1, wherein the maximum temperature set point comprises an absolute temperature value sent by the remote source.

3. The system of claim 1, wherein the maximum temperature set point comprises a change in temperature value sent by the remote source that is added to the ambient temperature as measured at a start of a control period.

4. The system of claim 1, wherein the local load interrupt information comprises a maximum run time per time unit, such that when the maximum run time per time unit is exceeded, the local controller actuates the switch so as to deactuate the local load.

5. The system of claim 4, wherein the analysis module is configured to prevent the switch from deactuating the local load when the ambient temperature is above the maximum temperature set point.

6. The system of claim 4, wherein the analysis module is configured to prevent the switch from deactuating the local load by scaling the maximum run time per time unit by a predetermined factor.

7. The system of claim 4, wherein the analysis module is configured to prevent the switch from deactuating the local load by scaling the maximum run time per time unit by a function of an inverse of a change in the ambient temperature across a predetermined time interval as sensed by the temperature sensor.

8. The system of claim 4, wherein the analysis module is configured to prevent the switch from deactuating the local load by scaling the maximum run time per time unit by a function of an inverse of a change in the ambient temperature across a predetermined time interval as sensed by the temperature sensor scaled by a function of an inverse of a remaining run time per time unit from the maximum run time per time unit.

9. The system of claim 1, wherein the local controller, the switch, the temperature sensor, the analysis module and the memory are disposed within a thermostat.

10. The system of claim 1, wherein the temperature sensor and the switch are disposed within a thermostat, wherein the thermostat is disposed within a building, further wherein the local controller, the memory, and the analysis module are disposed in a control unit disposed outside the building, further comprising a communication link between the control unit and the thermostat.

11. The system of claim 1, wherein the local controller, the switch, the memory and the analysis module are stored within a control unit, wherein the temperature sensor is stored within a temperature unit separate from the control unit, further comprising a communication link between the temperature unit and the control unit.

12. The system of claim 10, wherein the communication link comprises a wireless communication link.

13. A method of controlling a local HVAC load, the method comprising the steps of:
receiving a load control signal from a remote source, wherein the load control signal comprises local load interrupt information;
detecting a local ambient temperature;
retrieving a temperature set point;
comparing the local ambient temperature to the temperature set point; and
modifying the local load interrupt information by a factor based upon the local ambient temperature relative to the temperature set point.

14. The method of claim 13, further comprising the step of actuating a local load in accordance with the local load interrupt information.

15. The method of claim 14, wherein the local load interrupt information comprises a maximum local load run time per unit time.

16. The method of claim 15, wherein the step of modifying the local load interrupt information comprises actuating the local load when the ambient temperature exceeds the maximum temperature set point.

17. The method of claim 15, wherein the step of modifying the local load interrupt information comprises the step of scaling the maximum local load run time per unit time by a predetermined factor.

18. The method of claim 15, wherein the step of modifying the local load interrupt information comprises scaling the maximum local load run time per time unit by a function of an inverse of a change in ambient temperature across a predetermined time interval.

19. The method of claim 15, wherein the step of modifying the local load interrupt information comprises scaling the maximum local load run time per time unit by a function of an inverse of a change in ambient temperature across a predetermined time interval scaled by a function of an inverse of a remaining local load run time per time unit from the maximum local load run time per time unit.

20. The method of claim 15, wherein the step of modifying the local load interrupt information comprises increasing the maximum local load run time per unit time.

21. The method of claim 13, further comprising the step of delivering local load interrupt modification information to the remote source.

22. The method of claim 13, further comprising the step of accessing a communication system and transmitting a signal facilitiating modification of the local load interrupt information by the remote source once the maximum temperature set point.
